(19) United States
(12) Patent Application Publication
(10) Pub. No.: US 2013/0077235 A1
(43) Pub. Date: Mar. 28, 2013

(54) INTELLIGENT CASING FOR SMART DEVICES

(71) Applicants: SHARAD PAWAR, Bangalore (IN); SREEPATHI BHAT, Bangalore (IN); SAMPATH RAMACHANDRAN, Bangalore (IN); MANJUNATH GUNDARAO, Bangalore (IN)

(72) Inventors: SHARAD PAWAR, Bangalore (IN); SREEPATHI BHAT, Bangalore (IN); SAMPATH RAMACHANDRAN, Bangalore (IN); MANJUNATH GUNDARAO, Bangalore (IN)

(73) Assignee: BEWO TECHNOLOGIES PVT. LTD, Bangalore (IN)

(21) Appl. No.: 13/623,216

(22) Filed: Sep. 20, 2012

(30) Foreign Application Priority Data
Sep. 22, 2011 (IN) 3275/CHE/2011

(51) Int. Cl. G06F 1/16

(52) U.S. Cl. 361/679.56

(57) ABSTRACT

The various embodiments herein provide an intelligent protective casing for smart devices. The casing comprises a frame to releasably engage and hold a tablet device. The frame comprises an opening provided on the center for exposing a display panel of the tablet device, a printed circuit board (PCB), a microcontroller embedded in the PCB and a hardware circuitry interface for providing functional compatibility between the tablet device and the frame. The hardware circuitry includes a plurality of user configurable hardware features which are enabled according to user preferences. The user configurable hardware features comprises a fingerprint scanner, a thermal printer, one or more smart card readers, a magnetic swipe card reader, high amplitude speakers, a barcode scanner, an iris scanner, a projector, a solar panel, a back ground noise cancellation circuit, one or more noise cancellation microphones and at least one swappable battery to drive the circuitry.

### CROSS REFERENCE TO RELATED APPLICATION

The present application claims the priority of the Indian Provisional Patent application No. 3275/CHE/2011 filed on Sep. 22, 2011 having the title “Casing for smart devices” and the contents of which are incorporated by reference herein.

### BACKGROUND

1. Technical Field

The embodiments herein generally relate to casing for portable smart devices and particularly relates to a protective casing for tablet personal computers providing ergonomic access to the touch screen. The embodiments herein more particularly relate to a casing that includes hardware features and processing intelligence with an integral interface unit adapted to be configured to provide for compatibly with any smart tablet device.

2. Description of the Related Art

Tablet devices are becoming more popular and there is a demand for convenient carrying cases which offer easy access as well as protection of the device. The tablet devices have a touch screen technology which allows the user to operate the computer with a stylus or digital pen, or a fingertip, instead of a keyboard or mouse. Traditional protective casing for tablet devices store the device on one side of the case to provide full access to the touch screen to the user while the device remains in the case. However, typical cases does not offer any adjustability to be used easily with tablet devices of varying sizes, and also to allow easy attachment and detachment of the tablet from the case while also providing ease of carrying, ergonomic use, and adequate protection for the device while in use.

The conventional tablet devices do not include any hardware functional features such as thermal printer, noise cancellation circuitry, bar code reader, projector, projector support, protection hardware and the like.

Incorporating these functional features into the tablet device requires design and development steps including device ID design, board/PCB, firmware design, hardware driver development, machine tooling, manufacturing process and so on which all account to an extremely expensive process both in terms of time and money. Further, the hardware configurations need to be varied according to the requirements of various market verticals, which in turn need a complete cycle of manufacturing steps, resulting in a continued increase in costs. Further, the aforementioned development process needs to be repeated for a different microprocessor or for each reference design used. Even though the tablet device manufacturer incorporates the mentioned hardware features into the device, the user may not be in need/use of all these features.

In view of the foregoing, there is a need for a casing incorporated with the hardware features for providing functional features to a tablet device without incurring any additional manufacturing and operational costs. Further there is a need for a casing with an interface unit to provide for compatibility to incorporate additional functional hardware features in the tablet device based on the user's interest. Further, there is a need for a casing with a ruggedized form factor which facilitates an ergonomic structure and facilitates mobility of the tablet device.

The above mentioned shortcomings, disadvantages and problems are addressed herein and which will be understood by reading and studying the following specification.

### OBJECTIVES OF THE EMBODIMENTS

The primary object of the embodiments herein is to provide an intelligent casing with an integrated circuitry adapted to be configured for incorporating custom hardware features in a tablet device.

Another object of the embodiments herein is to provide an intelligent casing adapted to provide a compatible software platform for supporting additional custom hardware features in the tablet device without the need for a complete hardware re-design and software re-write of the tablet device.

Another object of the embodiments herein is to provide an intelligent casing to accommodate the tablet devices of various dimensions irrespective of the underlying reference design.

Another object of the embodiments herein is to provide an intelligent casing compatible for all types of tablet devices with different chipset/operating system.

Another object of the embodiments herein is to provide an intelligent casing with a single firmware compatible for the tablet devices of various operating systems to communicate with the casing.

Another object of the embodiments herein is to provide an intelligent casing with a ruggedized form factor.

Another object of the embodiments herein is to provide a casing which is ergonomically efficient and provides access to a communication network.

These and other objects and advantages of the present invention will become readily apparent from the following detailed description taken in conjunction with the accompanying drawings.

### SUMMARY

The various embodiments herein provide an intelligent casing for tablet devices. The casing comprises a frame to releasably engage and hold a tablet device. The frame comprises an opening provided on a center of the frame for exposing a display panel of the tablet device, a tablet printed circuit board (PCB) provided in the frame, a microcontroller embedded in the PCB and a hardware circuitry adapted to function an interface unit for providing a functional compatibility between the tablet device and the frame component. The hardware circuitry includes a plurality of user configurable hardware features which can be enabled according to a user preference.

According to an embodiment herein, the user configurable hardware feature comprises at least one of a fingerprint scanner, a thermal printer, one or more smart card readers, a magnetic swipe card reader, high amplitude speakers, a barcode scanner, an iris scanner, a projector, a solar panel, a back ground noise cancellation circuit, one or more noise cancellation microphones and at least one swappable battery to drive the circuitry.

According to an embodiment herein, the opening is configurable to adapt tablet devices of different shape and size to securely fit the tablet device.

According to an embodiment herein, the casing is adapted to provide port compatibility between the casing and the tablet devices of various shape and size.

According to an embodiment herein, the microcontroller embedded in the PCB is adapted to provide compatibility between the tablet device and the casing.

According to an embodiment herein, the microcontroller includes a plurality of API's for all firmware required for the hardware circuitry.

According to an embodiment herein, the casing further comprising a rugged form factor which is dustproof and waterproof.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates an isometric view of the intelligent casing for tablet devices, according to an embodiment herein.

FIG. 2 illustrates a block diagram of the configurable intelligent casing for tablet devices, according to an embodiment herein.

FIG. 3 illustrates a perspective front view of the intelligent casing for tablet devices, according to an embodiment herein.

FIG. 4 illustrates a perspective rear view of an intelligent casing for tablet devices, according to an embodiment herein.

FIG. 5 illustrates a perspective right side view of the intelligent casing, according to an embodiment herein.

FIG. 6 illustrates a perspective left side view of the intelligent casing, according to an embodiment herein.

Although specific features of the present invention are shown in some drawings and not in others. This is done for convenience only as each feature may be combined with any or all of the other features in accordance with the present invention.

### DETAILED DESCRIPTION OF THE EMBODIMENTS

In the following detailed description, a reference is made to the accompanying drawings that form a part hereof, and in which the specific embodiments that may be practiced is shown by way of illustration. The embodiments herein are described in sufficient detail to enable those skilled in the art to practice the embodiments herein and it is to be understood that the logical, mechanical and other changes may be made without departing from the scope of the embodiments herein. The following detailed description is therefore not to be taken in a limiting sense.

The various embodiments herein provide an intelligent protective casing for tablet devices. The casing comprises a frame to releasably engage and hold a tablet device. The frame comprises an opening provided on a centre of the frame for exposing a display panel of the tablet device, a tablet printed circuit board (PCB) provided in the frame, a microcontroller embedded in the PCB and a hardware circuitry adapted to function an interface unit for providing a functional compatibility between the tablet device and the frame component. The hardware circuitry includes a plurality of user configurable hardware features which can be enabled according to a user preference.

The user configurable hardware feature comprises at least one of a fingerprint scanner, a thermal printer, one or more smart card readers, a magnetic swipe card reader, high amplitude speakers, a barcode scanner, an iris scanner, a projector, a solar panel, a back ground noise cancellation circuit, one or more noise cancellation microphones and at least one swappable battery to drive the circuitry.

The opening is provided with a shape and size compatible with a shape and size of the tablet device to securely fit the tablet device into the opening.

The microcontroller is adapted to customize the plurality of user configurable hardware features without a need for a direct communication between hardware features and the tablet device. The microcontroller includes a plurality of API's for all firmware required for driving the hardware circuitry to provide compatibility between the tablet device and the peripherals.

The casing is a made of a flexible polymeric material which has a rugged form factor so as to provide dust proof and water proof protection to the tablet device.

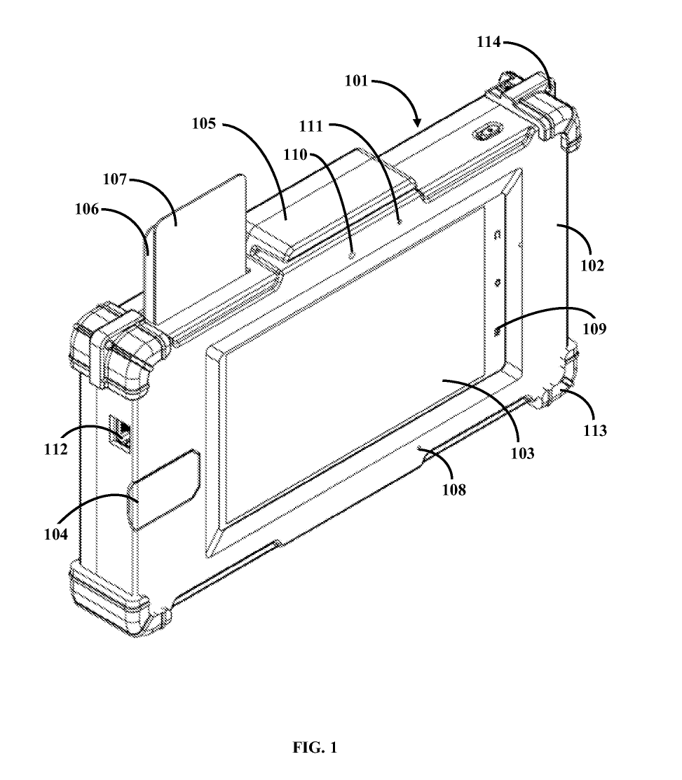

FIG. 1 illustrates an isometric view of the intelligent casing for tablet devices, according to an embodiment herein. The casing 101 includes a frame component 102 having an opening 103 adapted to releasably engage and hold a tablet device (not shown). The casing 101 is further provided with an integrated circuitry for incorporating customizable hardware features for the tablet device to expand the functional aspects and the capacity of the tablet device. The casing 101 includes a complementary software platform and a circuitry configured for providing a plurality of configurable hardware features to enable functional compatibility between the casing 101 and the tablet device.

The term tablet device as used herein refers to any single piece computing device having a visual screen or display on one side of the substantially flat casing, inside of which all the computing components are contained. While the casing 101 of the present invention is intended for use with such tablet devices, the tablet devices as such are not considered a part of the invention, and therefore are not described in greater detail.

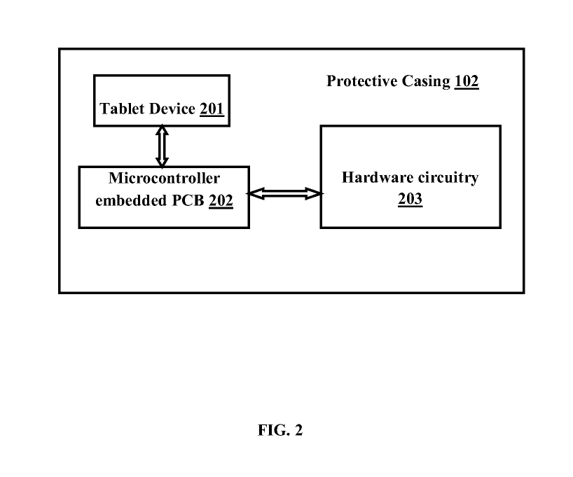

According to FIG. 1, the casing 102 includes a PCB containing a hardware circuitry (Ref. FIG. 2) which functions as an interface between the casing 101 and the tablet device to communicate to each other. The hardware circuitry is configured with one or more hardware features that enable the user of the tablet devices to perform much additional functionality which are not provisioned in the tablet device. The configurable hardware features include but not limited to a finger print scanner 104, a swipe card reader 105, smart card readers 106 and 107, one or more speakers 108 and one or more swappable batteries 109 dedicated to drive the integrated hardware circuitry. The hardware features further includes a front camera 110, one or more microphones 111, a noise cancellation circuitry embedded part of microcontroller, one or more wireless communication means such as infrared, Bluetooth and the like. The casing as shown in FIG. 1 also includes an Ethernet port 112 for enabling access to wired internet connection in rural areas where wireless transmission is limited. The user is able to customize the tablet device 101 through one or more configurable hardware features incorporated in the casing 102. The casing 101 attached to the tablet device function seamlessly as a single device for all practical purposes.

The casing 101 is further provided with a rugged form factor for enhanced protection. The rugged structure 113 is provided generally on the corners of the casing 101. The rugged structure 113 is made of a flexible material which provides improved shock resistance as compared to other display screen cushioning that is merely positioned at the corners of the display screen. The rugged structure 113 is connected internally with the casing by a washer and a square nut (not shown). In addition, the casing 101 also include at least one tag holder 114. The tag holders 114 are retractable and can be used according to the user requirements.

FIG. 2 illustrates a block diagram of the configurable intelligent casing for tablet devices, according to an embodiment herein. According to FIG. 2, the casing 101 is adapted to function is conjunction with any tablet device 201 irrespective of any structural differences. The casing 101 comprises a microcontroller embedded Printed Circuit Board (PCB) 202. The PCB includes a hardware circuitry 203 adapted to provide a plurality of user configurable hardware features. The microcontroller supports the custom hardware features without the need of any modification or installation in the tablet device 201. The hardware features are complemented by a software platform running both on the tablet device 201 and the microcontroller. The microcontroller card includes API's for all the firmware required to drive the hardware circuitry 203. The complementary software detects the different hardware features and further automatically enables the drivers and the APIs, required to enable communication between the tablet device 201 and the hardware features on the casing 101 through the microprocessor. The configurable hardware features are customizable according to user's requirement.

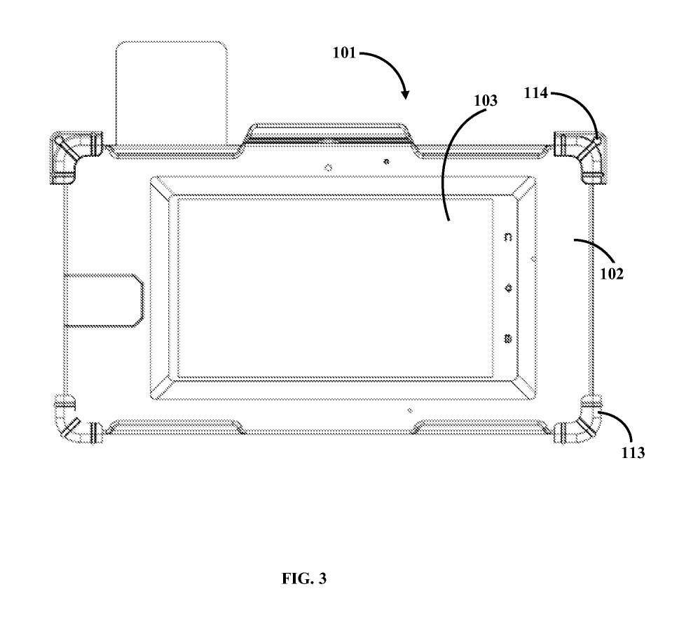

FIG. 3 illustrates perspective front view of the intelligent casing, according to an embodiment herein. The casing 101 is provided with an opening 103 in the centre section adapted to accommodate a tablet device 201 such as a tablet PC. The frame component 102 of the casing 101 incorporates one or more hardware features. The complementary software running both on the tablet device and the microcontroller of the casing 101 provides communication between the tablet device and the casing 101. The opening 103 as shown in FIG. 3 is adapted to receive a tablet device substantially of a rectangular shape. However other shapes and aspect ratios are contemplated in accordance with the present invention, including square, cuboidal and other shapes supporting a viewable display unit. Further the frame components 102 of the casing 101 can be of various sizes to receive tablet devices of different dimensions irrespective of the underlying reference de sign.

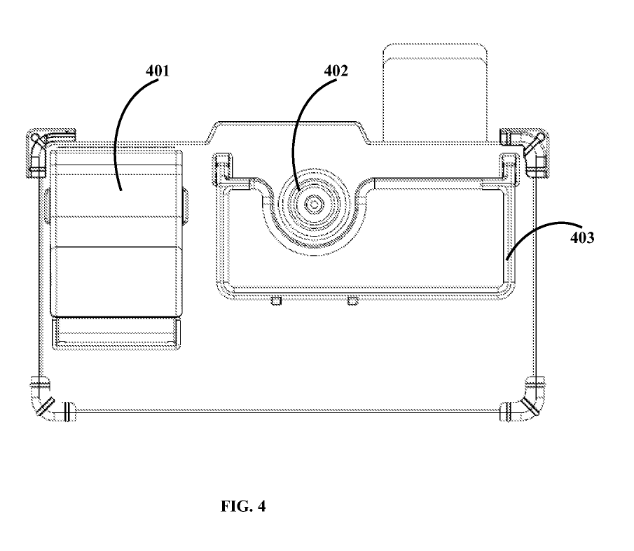

FIG. 4 illustrates a perspective rear view of an intelligent casing for tablet devices, according to an embodiment herein. The rear view of the casing 102 is flat and does not have any openings. The rear side of the casing includes a thermal printer 401, a rear camera 402 and a casing stand 403.

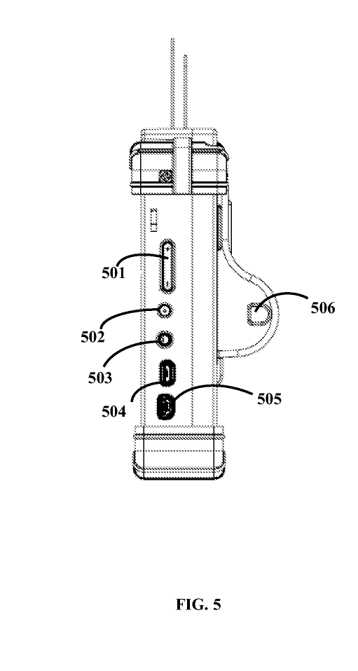

FIG. 5 illustrates a perspective right side view of the casing, according to an embodiment herein. The right side of the casing includes a volume button 501 to increase or decrease the sound profile during a voice call or any voice file, an audio input 502 for connecting an earphone, a charger port 503 for connected the charger for charging the device and two USB slots 504 and 505. The right view also shows a printer paper level indicator window 506 provided in the casing.

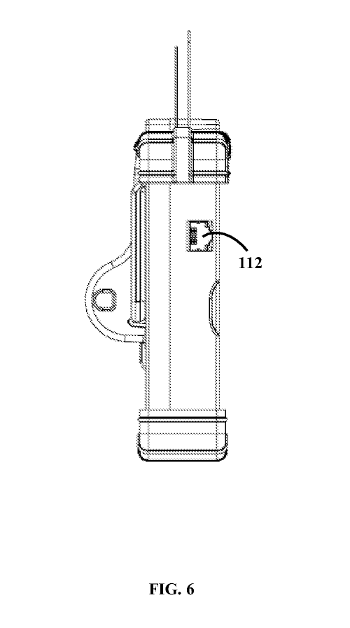

FIG. 6 illustrates a perspective left side view of the casing, according to an embodiment herein. The left side of the casing includes an Ethernet port 112 to provide for a wired internet connection.

The casing is made up of a polymeric material or any other suitable material which is flexible, tamper proof, water proof, dust proof and resistant to shocks.

The casing is generally formed from a polymeric material comparable in composition to the plastic of typical personal computers. In an alternate embodiment, however, the casing formed, at least in part, from a softer foam rubber or plastic, preferably with a hard plastic internal ribbing or frame. The softer casing provides adequate structural support while absorbing more impact for example, during a drop from a height, as compared with a typical hard plastic casing. The softer foam also provides improved comfort for a user to hold the tablet device in his or her hand or lap.

The various embodiments herein provide an intelligent protective casing with an integrated circuitry for incorporating customizable hardware features in a tablet device. The casing is efficient and cost effective in providing various additional features to a user of the tablet device which are not provided in the tablet device.

The casing includes an additional circuitry installed within to provide for additional features without taking up any processing speed or memory of the tablet device. Further the casing functions as an interface between the application software of the tablet and the integrated hardware features irrespective of the operating system/underlying design and is adaptable to receive tablet devices of different shapes and sizes.

The casing is able to support new custom features without the need for development on the tablet device microprocessor. Once the firmware is developed for the hardware features to communicate with the microcontroller in the casing, only minimal changes are required in API's to establish communication with a new tablet device that may have an entirely different chipset/OS than a conventional tablet device.

The casing is fabricated of a material having a form factor adapted to prevent entry of foreign particles such as dust, water and the like and is flexible to resist the shocks the tablet device may be subjected to during use, thereby increasing the life of the tablet device.

The provision of solar panel and additional battery in the casing provides continuous power to the tablet device thereby extending the operational time of the tablet devices.

The foregoing description of the specific embodiments will so fully reveal the general nature of the embodiments herein that others can, by applying a current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An intelligent casing for tablet devices comprising:
a frame to releasably engage and hold a tablet device, wherein the frame comprises;
an opening provided on a center of the frame for exposing a display panel of the tablet device;
a printed circuit board (PCB) provided in the frame;
a microcontroller embedded in the PCB; and
a hardware circuitry adapted to function as an interface for providing a functional compatibility between the tablet device and the frame;
wherein the hardware circuitry includes a plurality of user configurable hardware features which is enabled according to a user preference.

2. The casing of claim 1, wherein the user configurable hardware feature comprises at least one of:
a fingerprint scanner;
a thermal printer;
one or more smart card readers;
a magnetic swipe card reader;
high amplitude speakers;
a barcode scanner;
an iris scanner;
a projector;
a solar panel;
a back ground noise cancellation circuit;
one or more noise cancellation microphones; and
at least one swappable battery to drive the circuitry.

3. The casing of claim 1, wherein the opening is configurable to adapt tablet devices of different shape and size to securely fit the tablet device.

4. The casing of claim 1, is adapted to provide port compatibility between the casing and the tablet devices of various shape and size.

5. The casing of claim 1, wherein the microcontroller is adapted to customize the plurality of user configurable hardware features without a need for a direct communication between hardware features and the tablet device.

6. The casing of claim 1, wherein the microcontroller is further adapted to provide compatibility between the tablet device and the casing.

7. The casing of claim 1, wherein the microcontroller includes a plurality of API's for all firmware required for driving the hardware circuitry.

8. The casing of claim 1, further comprising a rugged form factor which is dust proof and water proof.
